(19) United States
(12) Patent Application Publication
(10) Pub. No.: US 2024/0394671 A1
(43) Pub. Date: Nov. 28, 2024

(54) SYSTEM, METHOD, AND COMPUTER PROGRAM PRODUCT FOR SECURE TRANSACTIONS

(71) Applicant: Simon GRUNFELD, Rockville Centre, NY (US)

(72) Inventor: Simon GRUNFELD, Rockville Centre, NY (US)

(21) Appl. No.: 18/202,883

(22) Filed: May 26, 2023

(51) Int. Cl. G06Q 20/06; G06Q 20/02; G06Q 20/10

(52) U.S. Cl. CPC G06Q 20/0655; G06Q 20/02; G06Q 20/108

(57) ABSTRACT

The system, method, and computer program product described herein may provide the capability to securely handle a variety of types of transactions, such as cryptocurrency transactions. For example, in an embodiment, a method of processing digital transactions of a digital asset in a network of computer systems may comprise receiving a request for a transaction, when the request for the transaction is accepted, initiating the transaction, placing in escrow currency from a buyer in the transaction, when confirmation is received that the currency from the buyer is in escrow, transferring the digital asset from a seller in the transaction to the buyer, and when confirmation of the transfer of the digital asset is received, releasing the escrow and transferring the currency to the seller.

### BACKGROUND OF THE INVENTION

The present invention relates to a system, method, and computer program product that may provide the capability to securely handle a variety of types of transactions, such as cryptocurrency transactions.

A cryptocurrency exchange is a system that allows buyers and sellers to trade cryptocurrencies or digital currencies for, for example, conventional currency. Security of exchange transactions, both in terms of handling of the conventional currency and the cryptocurrency is of paramount importance. Accordingly, a need arises for techniques that provide secure handling of a variety of types of transactions, such as cryptocurrency transactions.

### SUMMARY OF THE INVENTION

The present invention relates to a system, method, and computer program product that may provide the capability to securely handle a variety of types of transactions, such as cryptocurrency transactions.

For example, in an embodiment, a method of processing digital transactions of a digital asset in a network of computer systems may comprise receiving a request for a transaction, when the request for the transaction is accepted, initiating the transaction, placing in escrow currency from a buyer in the transaction, when confirmation is received that the currency from the buyer is in escrow, transferring the digital asset from a seller in the transaction to the buyer, and when confirmation of the transfer of the digital asset is received, releasing the escrow and transferring the currency to the seller.

In embodiments, the digital asset may be crypto currency. The request for the transaction may be received from the buyer and the seller accepts the transaction. The request for the transaction may be received from the seller and the buyer accepts the transaction. Transfer of the digital asset to the buyer may be recorded in a blockchain ledger. The confirmation of the transfer of the digital asset may be received from the blockchain ledger.

In an embodiment, a system for processing digital transactions of a digital asset in a network of computer systems, the system comprising a processor, memory accessible by the processor, and computer program instructions stored in the memory and executable by the processor to perform receiving a request for a transaction, when the request for the transaction is accepted, initiating the transaction, placing in escrow currency from a buyer in the transaction, when confirmation is received that the currency from the buyer is in escrow, transferring the digital asset from a seller in the transaction to the buyer, and when confirmation of the transfer of the digital asset is received, releasing the escrow and transferring the currency to the seller.

In an embodiment, a computer program product for processing digital transactions of a digital asset in a network of computer systems, the computer program product comprising a computer readable medium and computer program instructions stored on the computer readable medium and executable by a processor to perform receiving a request for a transaction, when the request for the transaction is accepted, initiating the transaction, placing in escrow currency from a buyer in the transaction, when confirmation is received that the currency from the buyer is in escrow, transferring the digital asset from a seller in the transaction to the buyer, and when confirmation of the transfer of the digital asset is received, releasing the escrow and transferring the currency to the seller.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary diagram of a system in which the system, method, and computer program product described herein may implemented.

FIG. 2 is an exemplary data flow diagram of the creation of a smart contract in the system shown in FIG. 1.

FIG. 3 is an exemplary process flow diagram of the invocation of a smart contract in the system shown in FIG. 1.

FIG. 4 is an exemplary block diagram of a computer system in which processes involved in the system, method, and computer program product described herein may be implemented.

### DETAILED DESCRIPTION OF THE INVENTION

The system, method, and computer program product described herein may provide the capability to securely handle a variety of types of transactions, such as crypto currency transactions.

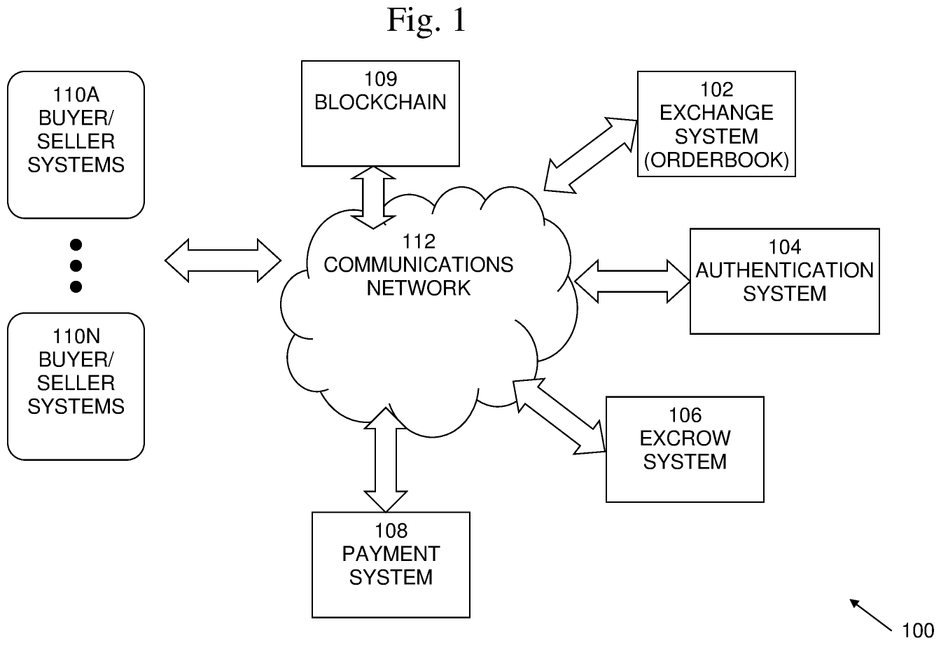

An exemplary system 100 in accordance with embodiments of the present invention is shown in FIG. 1. In this example, system 100 may include an exchange system 102, an authentication system 104, an escrow system 106, a payment system 108, a plurality of buyer/seller systems 110A-N, and communications networks 112. Exchange system 102 may include hardware and software to implement an exchange orderbook on which buyers and sellers may post bids and asks for, for example, crypto currency (crypto). The exchange orderbook may provide the capability to match bids and asks, receive acceptances of bids and asks, and initiate orders. Authentication system 104 may include hardware and software to implement buyer, seller, and transaction authentication processing. Escrow system 106 may include hardware and software to implement secure escrow processing of fiat or legal tender currencies (funds) involved in transactions being processed. Payment system 108 may include hardware and software to implement transfer of funds between entities involved in the transactions being processed, such as between buyers, sellers, and escrow system 106. Buyer/seller systems 110A-N may include hardware and software to implement buying and selling of, for example, crypto. Communications network 112 may provide communications among all systems 102-110.

In embodiments, systems 102-110 may include devices such as smartphone, tablets, personal digital assistants, etc., which may provide interface, computing, and communications capabilities that may be used to implement data entry, display, and administrative functions according to embodiments of the present systems and methods. In embodiments, systems 102-110 may include devices such as personal computers, laptop computers, workstations, etc., which may provide interface, computing, and communications capabilities that may be used to implement data entry, display, and administrative functions according to embodiments of the present systems and methods. Further, in embodiments, systems 102-110 may include server computer systems, data centers, cloud computing systems, etc. In embodiments, communications network 108 may include any wired or wireless, public or private, standard or proprietary data communication networks. For example, communications network 108 may include local area networks, wide area networks, wireless networks, telecommunications carrier networks, the Internet, etc.

It is to be noted that, in FIG. 1, examples of particular devices and communicative connections are shown. These devices and communicative connections are merely examples. Rather and types and arrangements of devices and communicative connections may be utilized.

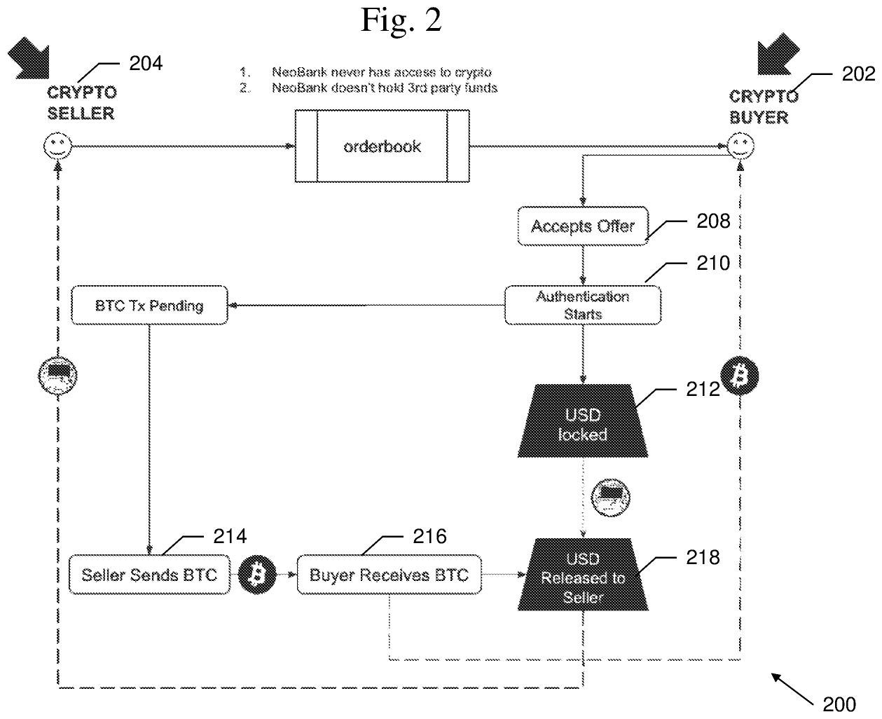

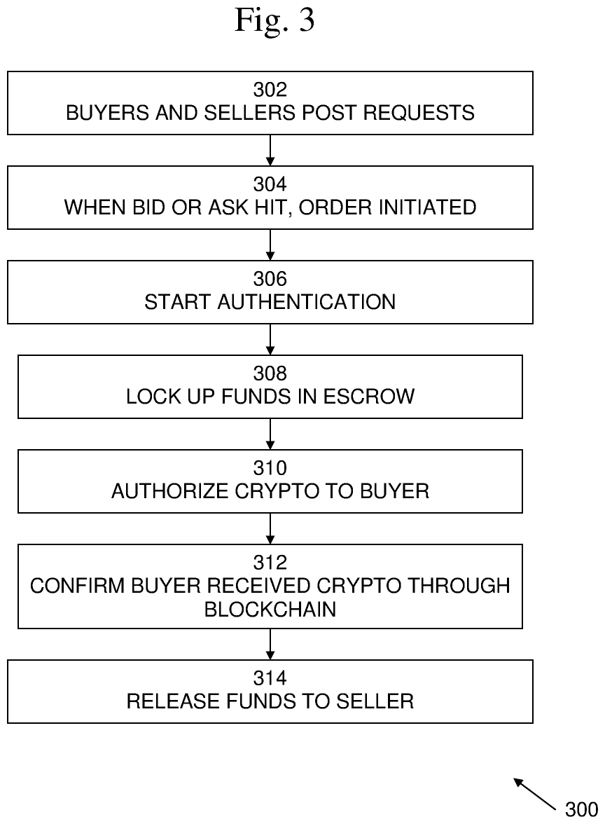

An exemplary data flow diagram 200 of processing that may be performed in system 100 is shown in FIG. 2. It is best viewed in conjunction with FIG. 3, which is a flow diagram of a process 300 of transaction processing, and FIG. 1. Process 300 begins with 302, in which buyers 202, using buyer/seller systems 110A-N, may post bids for crypto on orderbook 206 (which may be implemented in exchange system 102), and in which sellers 204, using buyer/seller systems 110A-N, may post asks for crypto on orderbook 206. Orderbook 206 may accept bids and asks, post them, and accept buyer acceptances of asks and seller acceptances of bids. When a bid or ask is accepted, for example, acceptance 208 of an ask from crypto seller 204 by crypto buyer 202, then at 304, an order is initiated.

At 306, authentication of the initiated order is started 210. Authentication may be performed, for example, by authentication system 104. At 308, currency from crypto buyer 204 may be transferred, for example, by payment system 108, to escrow system 106, and may be locked in escrow 212. Crypto seller 204 may receive confirmation of the funds in escrow and at 310 may send the crypto 214 to crypto buyer 202. Crypto buyer 202 may receive the crypto 216 and at 2, confirm receipt of the crypto. Typically, crypto transactions may be recorded in a blockchain ledger 109, so crypto buyer 202 may receive confirmation of receipt of the crypto from block chain ledger 109. Once crypto buyer 202 receives confirmation of receipt of the crypto, escrow system 106 may release 218 the escrowed currency to crypto seller 204.

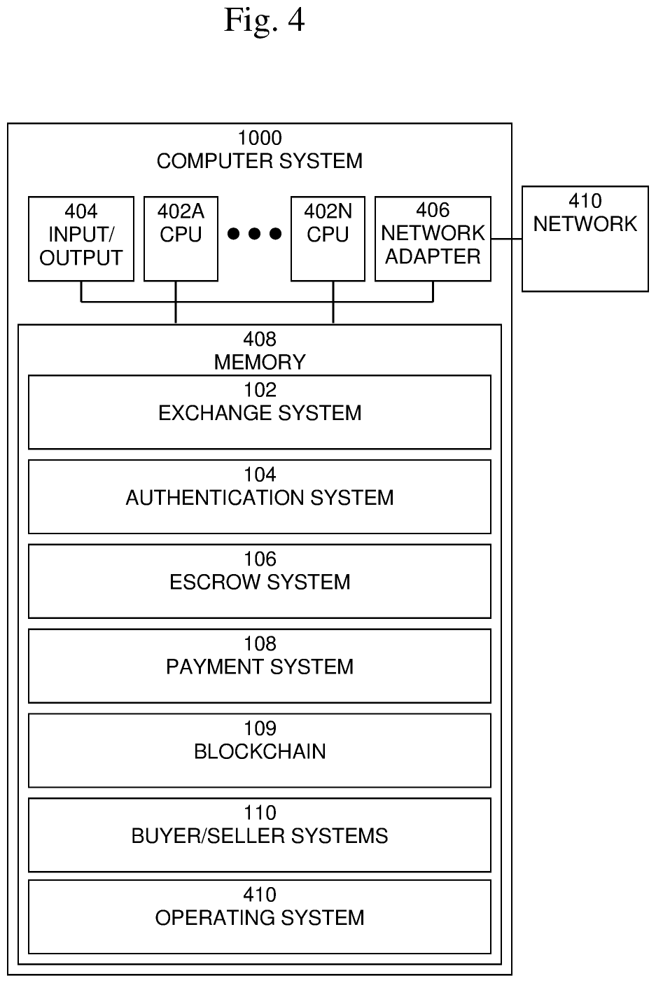

An exemplary block diagram of a computer system 400, in which the processes involved in the system, method, and computer program product described herein may be implemented, is shown in FIG. 4. Computer system 400 is typically a programmed general-purpose computer system, such as a personal computer, workstation, server system, and minicomputer or mainframe computer. Computer system 400 may include one or more processors (CPUs) 402A-402N, input/output circuitry 404, network adapter 406, and memory 408. CPUs 402A-402N execute program instructions in order to carry out the functions of the present invention. Typically, CPUs 402A-402N are one or more microprocessors, such as an INTEL PENTIUM®processor. FIG. 4 illustrates an embodiment in which computer system 400 is implemented as a single multi-processor computer system, in which multiple processors 402A-402N share system resources, such as memory 408, input/output circuitry 404, and network adapter 406. However, the present invention also contemplates embodiments in which computer system 400 is implemented as a plurality of networked computer systems, which may be single-processor computer systems, multi-processor computer systems, or a mix thereof.

Input/output circuitry 404 provides the capability to input data to, or output data from, computer system 400. For example, input/output circuitry may include input devices, such as keyboards, mice, touchpads, trackballs, scanners, etc., output devices, such as video adapters, monitors, printers, etc., and input/output devices, such as, modems, etc. Network adapter 406 interfaces device 400 with a network 410. Network 410 may be any public or proprietary LAN or WAN, including, but not limited to the Internet.

Memory 408 stores program instructions that are executed by, and data that are used and processed by, CPU 402 to perform the functions of computer system 400. Memory 408 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a fiber channel-arbitrated loop (FC-AL) interface.

The contents of memory 408 varies depending upon the function that computer system 400 is programmed to perform. For example, as shown in FIG. 1, computer systems may perform a variety of roles in the system, method, and computer program product described herein. For example, computer systems may perform one or more roles as users, validators, auditors, and/or identity providers. In the example shown in FIG. 4, exemplary memory contents are shown representing routines for all of these roles. However, one of skill in the art would recognize that these routines, along with the memory contents related to those routines, may be included on one system, or may be distributed among a plurality of systems, based on well-known engineering considerations. The present invention contemplates any and all such arrangements.

In the example shown in FIG. 4, memory 408 may include software to implement functionality of exchange systems 102, authentication systems 104, escrow systems 106, payment systems 108, buyer/seller systems 110, and operating system 424. Exchange system 102 may implement an exchange orderbook on which buyers and sellers may post bids and asks for, for example, cryptocurrency (crypto). The exchange orderbook may provide the capability to match bids and asks, receive acceptances of bids and asks, and initiate orders. Authentication system 104 may implement buyer, seller, and transaction authentication processing. Escrow system 106 may implement secure escrow processing of fiat or legal tender currencies (funds) involved in transactions being processed. Payment system 108 may implement transfer of funds between entities involved in the transactions being processed, such as between buyers, sellers, and escrow system 106. Buyer/seller system 110 may implement buying and selling of, for example, crypto. Operating system 410 provides overall system functionality.

As shown in FIG. 4, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including Linux, UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

It is important to note that while aspects of the present invention have been described in the context of a fully functioning data processing system, those of ordinary skill in the art will appreciate that the processes of the present invention are capable of being distributed in the form of a computer program product including a computer readable medium of instructions. Examples of non-transitory computer readable media include storage media, examples of which include, but are not limited to, floppy disks, hard disk drives, CD-ROMs, DVD-ROMs, RAM, and, flash memory.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method of processing digital transactions of a digital asset in a network of computer systems comprising:
receiving a request for a transaction;
when the request for the transaction is accepted, initiating the transaction;
placing in escrow currency from a buyer in the transaction;
when confirmation is received that the currency from the buyer is in escrow, transferring the digital asset from a seller in the transaction to the buyer; and
when confirmation of the transfer of the digital asset is received, releasing the escrow and transferring the currency to the seller.

2. The method of claim 1, wherein the digital asset is cryptocurrency.

3. The method of claim 1, wherein the request for the transaction is received from the buyer and the seller accepts the transaction.

4. The method of claim 1, wherein the request for the transaction is received from the seller and the buyer accepts the transaction.

5. The method of claim 1, wherein transfer of the digital asset to the buyer is recorded in a blockchain ledger.

6. The method of claim 5, wherein the confirmation of the transfer of the digital asset is received from the blockchain ledger.

7. A system for processing digital transactions of a digital asset in a network of computer systems, the system comprising a processor, memory accessible by the processor, and computer program instructions stored in the memory and executable by the processor to perform: receiving a request for a transaction;
when the request for the transaction is accepted, initiating the transaction;
placing in escrow currency from a buyer in the transaction;
when confirmation is received that the currency from the buyer is in escrow, transferring the digital asset from a seller in the transaction to the buyer; and
when confirmation of the transfer of the digital asset is received, releasing the escrow and transferring the currency to the seller.

8. The system of claim 7, wherein the digital asset is cryptocurrency.

9. The system of claim 7, wherein the request for the transaction is received from the buyer and the seller accepts the transaction.

10. The system of claim 7, wherein the request for the transaction is received from the seller and the buyer accepts the transaction.

11. The system of claim 7, wherein transfer of the digital asset to the buyer is recorded in a blockchain ledger.

12. The system of claim 11, wherein the confirmation of the transfer of the digital asset is received from the blockchain ledger.

13. A computer program product for processing digital transactions of a digital asset in a network of computer systems, the computer program product comprising a computer readable medium and computer program instructions stored on the computer readable medium and executable by a processor to perform:
receiving a request for a transaction;
when the request for the transaction is accepted, initiating the transaction;
placing in escrow currency from a buyer in the transaction;
when confirmation is received that the currency from the buyer is in escrow, transferring the digital asset from a seller in the transaction to the buyer; and when confirmation of the transfer of the digital asset is received, releasing the escrow and transferring the currency to the seller.

14. The computer program product of claim 13, wherein the digital asset is cryptocurrency.

15. The computer program product of claim 13, wherein the request for the transaction is received from the buyer and the seller accepts the transaction.

16. The computer program product of claim 13, wherein the request for the transaction is received from the seller and the buyer accepts the transaction.

17. The computer program product of claim 13, wherein transfer of the digital asset to the buyer is recorded in a blockchain ledger.

18. The computer program product of claim 17, wherein the confirmation of the transfer of the digital asset is received from the blockchain ledger.
